(19) United States
(12) Patent Application Publication
(10) Pub. No.: US 2009/0255542 A1
(43) Pub. Date: Oct. 15, 2009

(54) MASK NOSE CLIP AND A RESPIRATORY MASK

(75) Inventors: Haruna Ugai, Tokyo (JP); Makoto Nagase, Tokyo (JP)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/414,792

(22) Filed: Mar. 31, 2009

(30) Foreign Application Priority Data
Apr. 11, 2008 (JP) 2008-103987

(51) Int. Cl. A62B 9/06

(52) U.S. Cl. 128/863

(57) ABSTRACT

A nose clip 10 is a resinous strip-shaped member having the flexibility that permits easy deformation and the shape-retaining capability that permits the shape after deformation to be retained. The nose clip 10 includes a strip-shaped clip body 12 having a major surface 12a, a back surface 12b opposite to the major surface 12a, and a pair of edges 12c extending in a longitudinal direction, and a plurality of linear grooves 14 formed on the major surface 12a of the clip body 12, each linear groove extending in a direction intersecting both edges 12c of the clip body 12. The plurality of linear grooves 14 includes a plurality of first linear grooves 14a intersecting both edges 12c of the clip body 12 at generally right angle α, a plurality of second linear grooves 14b intersecting both edges 12c at an acute angle β, and a plurality of third linear grooves 14c intersecting both edges 12c at an acute angle γ.

### CROSS-REFERENCE TO RELATED APPLICATION

This application claims the benefit of Japanese application No. 2008-103987, filed Apr. 11, 2008.

The present invention relates to a nose clip for a mask and to a mask including the nose clip.

### BACKGROUND

A mask for medical applications and for safety and hygienic applications—including a mask body formed of filter material for covering a mouth and a nose of a wearer and a nose clip (also called as a nose fitter) mounted to the edge portion of the mask body adapted to be deformed along the nose and cheek of the wearer so as to improve close fit between the edge portion of the mask body and the face—has been conventionally known. The nose clip typically is a strip-shaped member that has sufficient flexibility to be easily deformed and shape-retaining capability to retain the shape after deformation, and is conventionally formed from metal, synthetic resin, or the like.

For example, JP2005-035148 discloses a nose clip formed of resin material having shape-retaining property, and a face mask including the nose clip. The shape-retaining material is formed from oriented polyolefin based resin with rolling ratio of 5 to 16 times, a draw ratio of 1.3 to 2.5 times, and the total draw ratio of 10 to 40 times. The nose clip formed of above-described shape retaining material has shape-retaining property suited to be used for a face mask.

A nose clip for a mask is required to have the capability of 3-dimensional deformation including bending and twisting so as to be able to conform to wide variety of nose shape of wearers as well as shape-retaining capability which permits the deformed shape to be retained at least against its own weight and self-restoring force. In particular, it is desired that a nose clip formed of resin have the 3-dimensional deformation capability and the shape-retaining capability comparable to a metallic nose clip.

It is also required for a mask including a nose clip that the nose clip can improve a fit feeling as a wearer's sense (in particular, a sense of contact imparted to the wearer by the outer periphery of the mask situated along the wings of a nose and cheeks) (e.g., in general use), and in addition, can maintain the close fit of the outer periphery of the mask body to the face (not only on the edge portion having the nose clip, but also along the entire periphery) for a long time in order to exhibit the full filtering function of the mask body (e.g., in industrial use).

### SUMMARY

It is an object of the present invention to provide a nose clip that has 3-dimensional deformation capability to conform to wide variety of nose shape of wearers and which has shape-retaining capability to retain the deformed shape for a long time.

It is another object of the present invention to provide a face mask including a nose clip, which is capable of improving a fit feeling as a wearer's sense by the use of the nose clip, and which is capable of maintaining the close fit between the outer periphery of the mask body and the wearer's face, and thereby exhibiting full filtering function of the mask body.

In order to accomplish the above object, one aspect of the present invention provides a nose clip comprising a strip-shaped clip body with a major surface and a back surface opposite to the major surface, the clip body having an edge extending in a longitudinal direction; and a plurality of linear grooves provided on at least one of the major surface and back surface of the clip body, each linear groove extending in a direction intersecting the edge of the clip body.

Another aspect of the present invention provides a mask comprising a mask body and a nose clip attached to the mask body, characterized in that the nose clip comprises a resinous nose clip having the above configuration.

The nose clip according to one aspect of the present invention has both 3-dimensional deformation capability of being deformed in a wide variety of forms including bending and twisting and shape-retaining capability of retaining the deformed shape at least against its own weight and self-restoring force. Thus, the nose clip, when attached to the edge portion of a mask and used, can conform to a wide variety of nose shapes of mask wearers so as to improve the close fit between the edge portion of the mask and the wearer's face.

The mask according to another aspect of the present invention includes a nose clip as described above, so that the sense of close fit of the wearer is improved, or that the close fit between the outer edge portion of the mask body and the face can be maintained for a long time so as to exhibit full filtering function of the mask body.

The present invention will be described in detail below with reference to appended drawings showing embodiments thereof Throughout the drawings, corresponding components are denoted by common reference numerals.

### BRIEF DESCRIPTION OF DRAWINGS

FIG. 1 is a perspective view showing a nose clip according to an embodiment of the present invention.

FIG. 2 is a perspective view showing an example of the shape after bending deformation of the nose clip of FIG. 1.

FIG. 3 is a side of a nose clip according to an embodiment of the present invention, respectively showing (a) a nose clip of FIG. 1, (b) a nose clip according to a modification, and (c) a nose clip according to another modification.

FIG. 4 is a view showing patterns of linear grooves of a nose clip according to an embodiment of the present invention, respectively showing (a) linear grooves of FIG. 1, (b) linear grooves according to a modification, (c) linear grooves according to another modification, (d) linear grooves according to still another modification, (e) linear grooves according to still another modification, (f) linear grooves according to still another modification, and (g) linear grooves according to still another modification.

FIG. 5 is a view showing a mask according to an embodiment of the present invention, showing (a) a plan view, and (b) a perspective view of the shape during usage.

FIG. 6 is a view showing a mask according to another embodiment of the present invention, showing (a) a plan view, and (b) a perspective view of the shape during usage.

FIGS. 7(a) to (c) are views useful for explaining a method of experiment for evaluating the characteristics of a nose clip according to an embodiment of the present invention.

### DETAILED DESCRIPTION

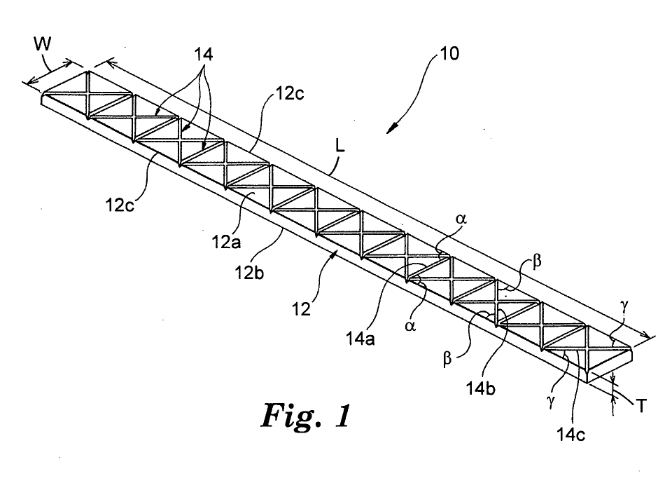

The nose clip 10 includes a strip-shaped clip body 12 having a major surface 12a, a back surface 12b opposite to the major surface 12a, and a pair of edges 12c extending in a longitudinal direction, and a plurality of linear grooves 14 formed on the major surface 12a of the clip body 12, each linear groove extending in a direction intersecting both edges 12c of the clip body 12. The clip body 12 has generally uniform thickness T except in the region of the linear grooves 14, generally uniform width W as a whole that is several times the thickness T, and generally uniform length L as a whole that is several to several dozens times the width W, and has in itself the flexibility that permits deformation from the plate-like shape of FIG. 1 to any desired shape, and the shape-retaining capability for retaining the deformed shape.

The plurality of linear grooves 14 includes a plurality of first linear grooves 14a intersecting both edges 12c of the clip body 12 generally parallel to each other at generally right angle α, a plurality of second linear grooves 14b intersecting both edges 12c of the clip body 12 at an acute angle β, and a plurality of third linear grooves 14c intersecting both edges 12c of the clip body 12 at an acute angle γ (mirror image of β in the Figure). Each of the linear grooves 14a to 14c extends in a straight line between both edges 12c of the clip body 12. A plurality of first linear grooves 14a are arranged parallel to each other and at regular interval, and a plurality of second linear grooves 14b are arranged parallel to each other and at the same regular interval as the first linear grooves 14a, and a plurality of third linear grooves 14c are arranged parallel to each other and at the same regular interval as the first and the second linear grooves 14a and 14b. One end of a first linear groove 14a intersects, at one edge 12c of the clip body 12, with respective one ends of a second linear groove 14b and one end of a third linear groove 14c, and the other end of a first linear groove 14a intersects, at the other edge 12c of the clip body 12, with the respective other ends of another second linear groove 14b and one end of another third linear groove 14c. In this manner, the plurality of linear grooves 14 (14a, 14b, 14c) are formed on the major surface 12a of the clip body 12 in a repeating pattern.

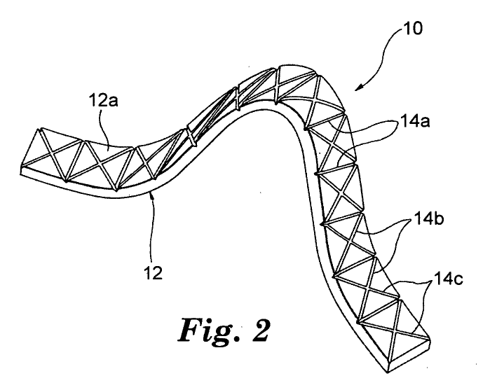

FIGS. 1 and 2 are views showing a nose clip 10 according to an embodiment of the present invention. The nose clip (also referred to as nose fitter) 10 is, as described later, a strip-shaped member having flexibility to permit easy deformation and shape-retaining capability for retaining the deformed shape, and is generally formed from synthetic resin material. The nose clip 10 can be used with a medical or safety and hygienic mask in a form attached to the edge portion of the mask in order to improve the close fit between the mask edge portion and the wearer's face.

In the nose clip 10, the plurality of linear grooves 14 (14a, 14b, 14c) formed on the major surface 12a of the clip body 12 acts such that the intrinsic flexibility and the shape-retaining capability of the clip body 12 is enhanced. Specifically, the plurality of first linear grooves 14a enhance the flexibility of the clip body 12 for bending in the direction perpendicular to the major surface 12a, and the plurality of second and third linear grooves 14b and 14c enhance the flexibility of the clip body 12 for twisting in left and right directions. Here, the flexibility enhancing effect of the linear grooves 14a to 14c is produced only locally on the major surface 12a of the clip body 12. Therefore, as compared to the construction in which the flexibility of the clip body 12 is increased as a whole (that is, the clip body becomes softer as a whole), impairment of the shape-retaining capability of the clip body 12 can be avoided. Since the self-restoring force of the clip body 12 seems to be reduced in the region of individual linear grooves 14a to 14c, overall shape-retaining capability is improved.

As described above, the nose clip 10 acquires both the 3-dimensional deformation capability of deforming in a wide variety of forms including bending and twisting, and shape-retaining capability of retaining the deformed shape at least against its own weight and self-restoring force in high level (an example of deformed shape is shown in FIG. 2). Therefore, when the nose clip 10 is attached to the edge portion of the mask (not shown) and used, it can conform to a wide variety of shapes of wearer's nose and can thereby improve the close fit between the mask edge portion and the wearer's face.

In the nose clip 10, the clip body 12 is made from a material having suitable plastic deformation property (composition of the specific example is described later). Such a material having suitable plastic deformation property can be suitably drawn and extended to obtain desired shape-retaining property. The clip body 12 is not limited to the plate shape having rectangular outline shown in the Figure, but may have any shape with variable width W and thickness T at desired portion. In this way, the nose clip 10 can exhibit suitable difference in the flexibility and the shape-retaining property depending on the position of deformation. The material of the clip body 12 is not particularly limited, but may include, for example, resin, elastomer, plastomer, or mixtures thereof. Specifically, examples of the material of the clip body 12 include polyester resins such as polyethylene-terephthalate (PET), polybutylene-terephthalate (PBT); polyolefin resins such as polyethylene, polypropylene, polybutylenes; polycarbonate (PC); styrene-ethylene-butylene-styrene copolymer (SEBS); polystyrene; epoxy resins such as epoxy polyethylene; or suitable mixtures of these resins. Length L, width W, and thickness T of the clip body 12 are not particularly limited, but may be suitably chosen in accordance with the size, shape and material of the mask to which the nose clip 10 is to be attached. For example, the length L may be set to about 30 mm or more, about 50 mm or more, or about 70 mm or more, and to about 250 mm or less, about 200 mm or less, or about 150 mm or less. For example, the width W may be set to about 2 mm or more, and to about 20 mm or less. For example the thickness T may be set to about 0.1 mm or more, or about 0.3 mm or more, and to about 5 mm or less, or about 3 mm or less.

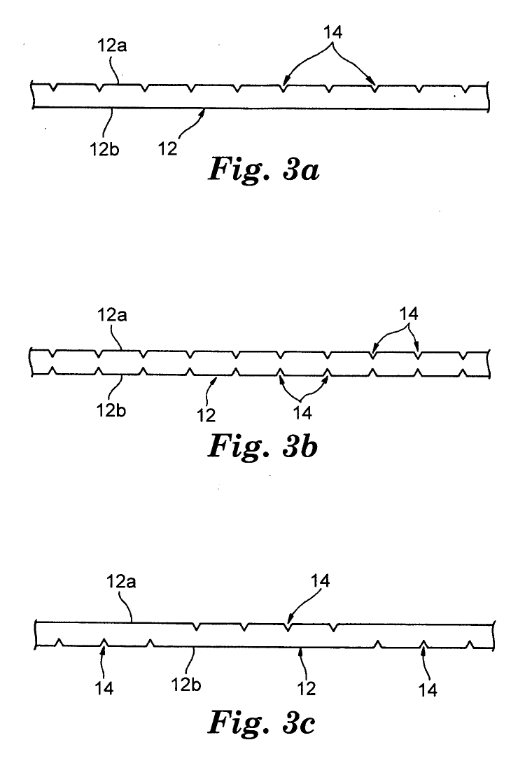

In the nose clip 10, the plurality of linear grooves 14 can be formed in desired repeating pattern, for example, by placing a processing roller having a plurality of protrusions as the male mold of the linear grooves 14 on outer circumferential surface and a supporting roller having a flat outer circumferential surface with respective outer circumferential surfaces in opposition to and a predetermined distance separated from each other, and by feeding into the nip between these rollers a clip body 12 formed in strip or plate shape or its material (such a processing method is herein referred to as emboss processing). In this case, each linear groove 14 can have a V-formed sectional shape as shown in FIG. 3(a). A linear groove 14 having other sectional shape, such as U-formed, rectangular, slit-form with minimum width, or the like, can be formed. Depth of the linear groove is not particularly limited, but can be suitably selected in accordance with thickness T, width W, length L, and material of the clip body 12, and can be set to, for example, about 1/20 or more, or 1/10 or more of the thickness T of the clip body 12, and to about ½ or less, or about ⅓ or less of the thickness T of the clip body 12. Specifically, depth can be set to, for example, about 0.1 mm or more, or 0.2 mm or more, and to about 2.5 mm or less, or about 2 mm or less.

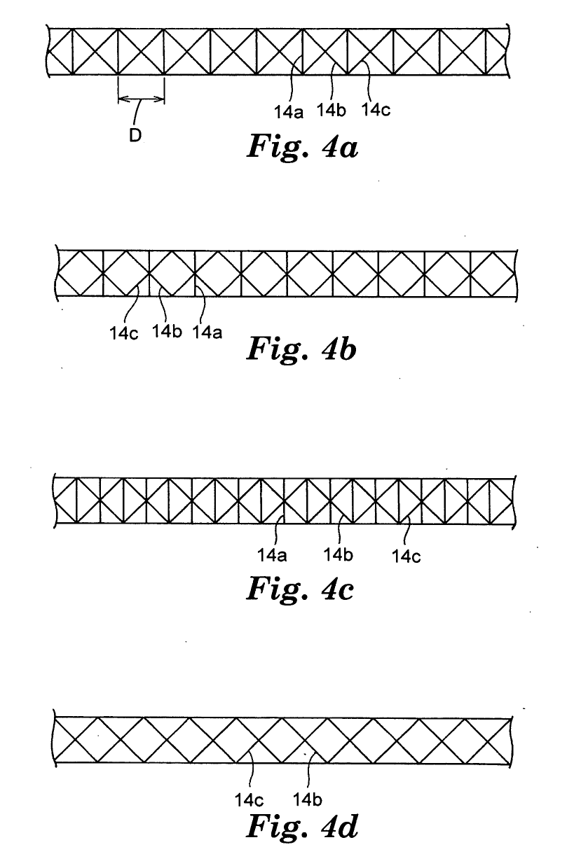

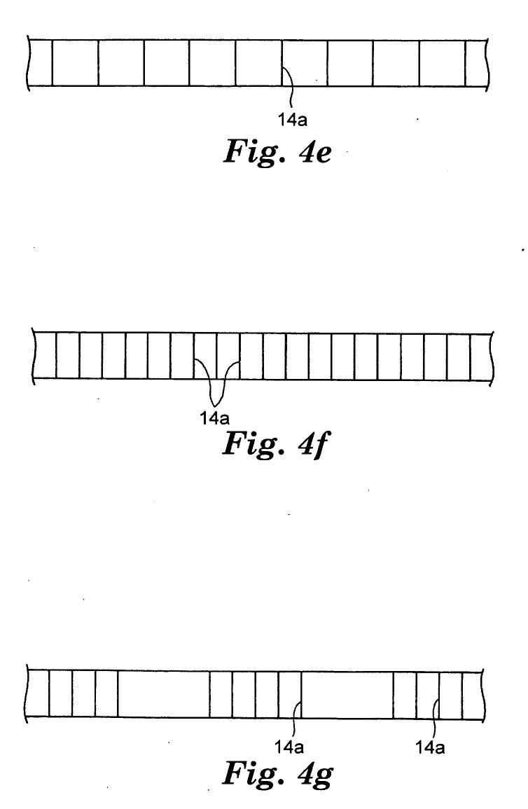

The plurality of linear grooves 14 may have varying construction in accordance with the level of flexibility and shape-retaining property required for the nose clip 10. For example, a plurality of linear grooves 14 may be formed not only on the major surface 12a of the clip body 12, but also on the back surface 12b. In this case, the plurality of linear grooves 14 may be formed on the major surface 12a and on the back surface 12b at same positions in the same pattern (FIG. 3(b)), or at different positions in different pattern or in the same pattern (FIG. 3(c)). Pattern of the linear grooves 14 is not limited to the combination pattern of the 1st to 3rd linear grooves 14a to 14c (FIG. 4(a)). For example, a combination pattern of the 1st to 3rd linear grooves 14a to 14c intersecting each other at respective centers (FIG. 4(b)), a combined pattern of (a) and (b) (FIG. 4(c)), a pattern with the 1st linear grooves 14a omitted in (a) (FIG. 4(d)), a pattern with 2nd and 3rd linear grooves 14b, 14c omitted in (a) (FIG. 4(e)), a pattern with the interval of 1st linear grooves 14a reduced in (e) (FIG. 4(f)), or a pattern with the interval of 1st linear grooves 14a locally enlarged in (f) (FIG. 4(g)) or the like may be adopted. Further, patterns shown in FIGS. 4(a) to (d) may be formed with the interval of corresponding linear grooves (for example, interval of 1st linear grooves 14a) wider in some portions and narrower in others. For example, the grooves may be formed with interval narrower in portions where the nose clip 10 needs to be bent to a relatively large extent, and with interval wider in other portions. Interval of the linear grooves 14 is not particularly limited, but may be set, for example, to about 0.5 mm or more, or about 1 mm or more, and to about 20 mm or less, or about 10 mm or less, or to about 5 mm or less.

In the construction shown, individual linear groove 14 terminates at both ends at the two edges 12c of the clip body 12, but the present invention may be constructed with at least one end terminating apart from the edge 12c of the clip body 12. In either case, each linear groove 14 extends in the direction toward intersection with the edges 12c of the clip body 12.

Next, the operative effect obtained by the plurality of linear grooves 14 will be described below in correspondence to the construction of the linear grooves 14 in a simplified manner.

In the construction in which the plurality of linear grooves 14 includes at least one linear groove 14 extending in a direction intersecting the edge 12c of the clip body 12 at an acute angle (for example, linear groove 14b or 14c), the flexibility and the shape-retaining capability of the clip body 12 is improved in one twisting direction by such a slanting linear groove 14.

In the construction in which the plurality of linear grooves 14 includes at least one linear groove 14 extending in a direction intersecting the edge 12c of the clip body 12 orthogonally at right angle (for example, linear groove 14a), the flexibility and the shape-retaining capability is improved in bending direction perpendicular to the major surface 12a of the clip body 12 by such a vertical linear groove 14.

In the construction in which the plurality of linear grooves 14 includes at least two linear grooves 14 extending in directions intersecting the edge 12c of the clip body 12 at angles different from each other (for example, linear groove 14b or 14c), the flexibility and the shape-retaining capability of the clip body 12 is improved in two or more twisting directions (or twisting angles) by such two or more linear grooves 14 slanting at different angles.

In the construction in which the plurality of linear grooves 14 includes at least two linear grooves 14 parallel to each other (for example, two or more linear grooves 14a, 14b or 14c), the flexibility and the shape-retaining capability of the clip body 12 is improved in a prescribed direction by such two or more parallel linear grooves 14.

In the construction in which the plurality of linear grooves 14 includes at least three linear grooves 14 arranged at regular interval (for example, three or more linear grooves 14a, 14b or 14c), the flexibility and the shape-retaining capability of the clip body 12 is improved in a prescribed direction by such three or more linear grooves 14 arranged at regular interval.

In the construction in which the plurality of linear grooves 14 are uniformly formed in a repeating pattern on the major surface 12a or on the back surface 12b of the clip body 12 (for example, the construction shown in FIGS. 4(a) to (f)), uniform flexibility and shape-retaining capability can be obtained irrespective of the position of deformation of the clip body 12. In this construction, in particular, when the nose clip is attached to the edge portion of the mask (not shown) and used, high level of close fit can be ensured between the edge portion of the mask and the wearer's face irrespective of the shape of the nose of the mask wearer.

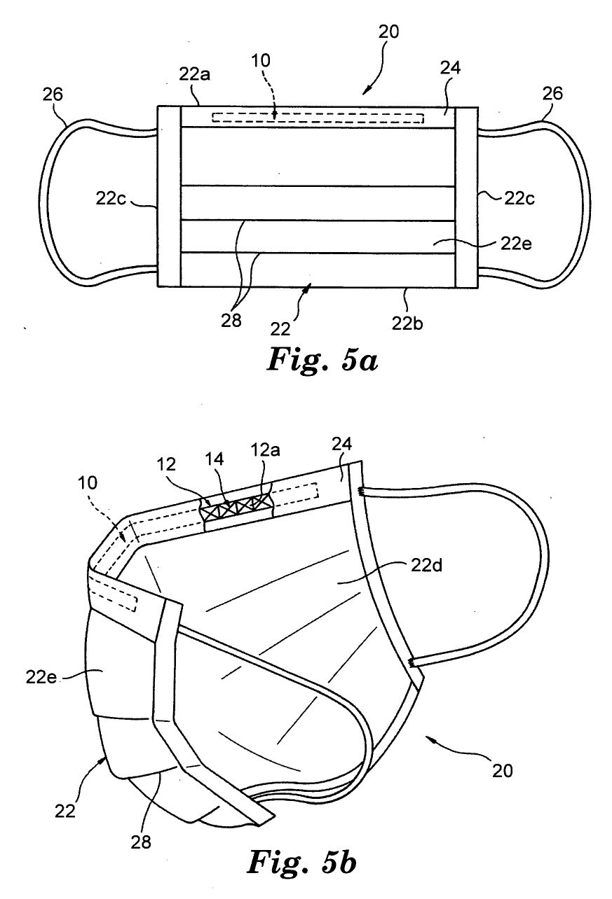

FIG. 5 shows a mask 20 including a nose clip 10 according to an embodiment of the present invention. The mask 20 includes a mask body 22 formed of filter material (such as non-woven fabric) which covers the mouth and nose of the wearer (not shown), and a nose clip 10 which is attached to the edge portion 24 of the mask body 22 and which is deformed along the nose and cheek of the wearer (not shown) so as to improve the close fit between the edge portion 24 of the mask body 22 and the wearer's face.

The mask body 22 has an upper edge 22a, a lower edge 22b, and both side edges 22c, in addition to an inner surface 22d and an outer surface 22e. In the state of proper usage of the mask 20, the upper edge 22a of the mask body 22 is disposed in transverse direction along the wearer's nose and both cheeks, the lower edge 22b is disposed in transverse direction along the wearer's lower jaw, both side edges 22c are disposed in vertical direction along both cheeks of the wearer, and the inner surface 22d is disposed in opposition to the nose and mouth of the wearer, and the outer surface 22e is oriented away from the wearer's face.

The mask body 22 has an edge portion 24 for attaching the nose clip 10 along the upper edge 22a, and a strap 26 is provided for hanging on the wearer's ear on each of side edges 22c. The mask body 22 further has a plurality of pleats 28 formed so as to extend between both side edges 22c. These pleats 28 permit the mask body 22 to be folded flat at the time of storage of the mask (FIG. 5(a)). At the time of usage of the mask, the pleats permit the mask body 22 to be spread vertically so as to form a desired space between the mask body 22 and the wearer's mouth (FIG. 5(b)). The mask body 22 having such a pleat structure is known in the field of general purpose mask.

In the mask 20, the nose clip 10 is attached to the mask body 22 such that the surface (the major surface 12a in the embodiment shown) of the clip body 12 having a plurality of linear grooves 14 formed thereon is oriented toward the wearer's nose. In the embodiment shown, the edge portion 24 of the mask body 22 is formed along the upper edge 22a in the shape of a bag, and the entire nose clip 10 is contained in the edge portion 24 with the major surface 12a of the clip body 12 oriented toward the inner surface 22e of the mask body 22. In this state, the nose clip 10 is fixed to the mask body 22, for example, at both longitudinal ends of the clip body 12. This construction provides a better fit feeling as a wearer's sense (especially, sense of contact given to the wearer by the mask upper edge 22a situated from the nose wing along both cheeks) as compared to the construction in which the entire nose clip 10 is contained in the edge portion 24 with the major surface 12a of the clip body 12 oriented toward the outer surface 22d of the mask body 22 (the sense of close fit will be quantitatively discussed later). In the case where the nose clip 10 has linear grooves 14 on both major surface 12a and the back surface 12b of the clip body 12 (for example, FIGS. 3(b), (c)), the nose clip 10 may be fixed to the mask body 22 with either the major surface 12a or the back surface 12b oriented toward the wearer's nose.

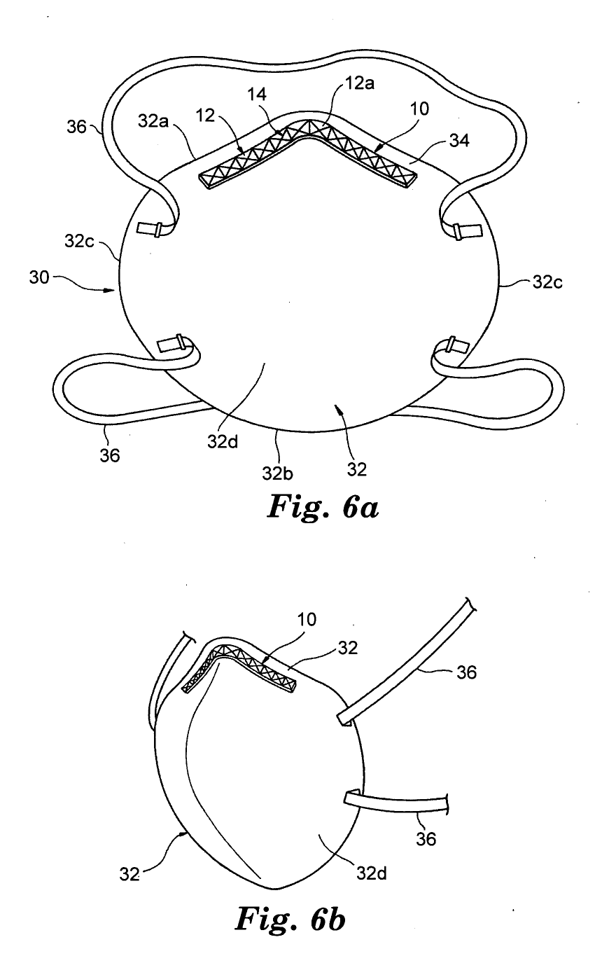

FIG. 6 shows a mask 30 including a nose clip 10 according to another embodiment of the present invention. The mask 30 includes a mask body 32 formed of filter material (such as non-woven fabric) which covers the mouth and nose of the wearer (not shown), and a nose clip 10 which is attached to the edge portion 34 of the mask body 32 and which is deformed along the nose and cheek of the wearer (not shown) so as to improve the close fit between the edge portion 34 of the mask body 32 and the wearer's face.

The mask body 32 has an upper edge 32a, a lower edge 32b, and both side edges 32c, in addition to an inner surface (not shown) and an outer surface 22d. In the state of proper usage of the mask 30, the upper edge 32a of the mask body 32 is disposed in transverse direction along the wearer's nose and both cheeks, the lower edge 32b is disposed in transverse direction along the wearer's lower jaw, both side edges 32c are disposed in vertical direction along both cheeks of the wearer, and the inner surface is disposed in opposition to the nose and mouth of the wearer, and the outer surface 32d is disposed in orientation away from the wearer's face.

The mask body 32 has an edge portion 34 for attaching the nose clip 10 along the upper edge 32a, and both ends of a pair of straps 36 for hanging on the wearer's head are fixed to a position near the upper edge and a position near the lower edge of both side edges 22c, respectively. The mask body 32 has a preformed cup-shape which permits desired space to be formed between the mask body 32 and the wearer's mouth at the time of mask usage. The mask body 32 having such a cup-shape is known in the field of industrial mask (for example, dust mask).

In the mask 30, the nose clip 10 is attached to the mask body 32 such that the surface (the major surface 12a in the embodiment shown) of the clip body 12 having a plurality of linear grooves 14 formed thereon is oriented toward the wearer's nose. In the embodiment shown, the edge portion 34 of the mask body 32 is formed on the outer surface 32d along the upper edge 32a, and the entire nose clip 10 is provided in the edge portion 34 with the major surface 12a of the clip body 12 oriented to the exterior exposed on the outer surface 32d of the mask body 32. In this state, the nose clip 10 is fixed to the mask body 32, for example, at both longitudinal ends of the clip body 12. This construction permits close fit between the outer edge of the mask 32 (not merely the edge portion 34 having the nose clip 10, but the entire outer edge (upper edge 32a, lower edge 32b and both side edges 32c)) and the face to be maintained for a long time in order to exhibit full filtering function of the mask body 32, as compared to the construction in which the entire nose clip 10 is provided in the edge portion 34 with the major surface 12a of the clip body 12 oriented to the interior not exposed on the outer surface 32d of the mask body 32 (the capability of maintaining the state of close fit will be quantitatively discussed later).

### EXAMPLE 1

### Experiment 1

In order to evaluate a fit feeling of a mask for general purpose (for example, mask 20), an experiment on the characteristics of a nose clip was performed as described below.

As an inventive example 1 of a nose clip, a strip-shaped resin material containing PET (polyethylene terephthalate), PC (polycarbonate), SEBS (styrene ethylene butylene styrene copolymer), PE (polyethylene) and EpxPE (epoxy polyethylene) in ratio by weight of PET/PC/SEBS/PE/EpxPE=55/15/15/12.5/2.5, and having thickness T=0.5 mm and width W=4 mm was subjected to emboss processing to form a plurality of linear grooves 14 in a continuous repeating pattern, and then, the strip-shaped material having linear grooves formed thereon was cut to pieces of length L=90 mm to obtain a nose clip 10 (FIG. 1). In the nose clip obtained, the interval D (FIG. 4(a)) of the first linear grooves 14a was 18 mm, the depth of each linear groove 14 was about 0.1 mm to 0.2 mm, and the cross-sectional shape of each linear groove 14 was generally U-shape (V-shape with rounded tip) of width about 0.5 mm to about 1 mm.

As an inventive example 2 of the nose clip, a resinous nose clip used in the product “Cleanline Kowa 3-dimensional Mask” manufactured by Kowa Company (Tyuuou-ku, Tokyo) was subjected to the same emboss processing to obtain same linear grooves as the 1st to 3rd linear grooves 14a to 14c of nose clip 10 as in inventive example 1.

As a comparative example 1, a nose clip of same material and same size as the nose clip 10 in Inventive example 1 but without the 1st to 3rd linear grooves 14a to 14c was provided.

As a comparative example 2, the resinous nose clip “Cleanline Kowa 3-dimensional Mask” (without linear grooves) used in Inventive example 2 was provided.

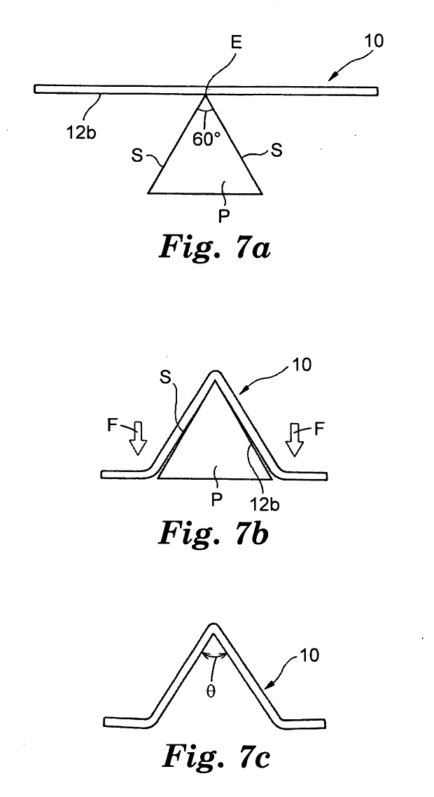

As shown in FIG. 7, a regular triangle prism P with a bottom side edge of 3 cm was provided, and the above-described nose clip 10 of inventive example 1 was abutted to an edge E of the side surface S of the regular triangle prism P (the interior angle of 60 degrees), with the longitudinal center of the back surface 12b of the clip body positioned at the edge E (FIG. 7(a)). In this state, a suitable pressing force F is applied to the nose clip 10 so as to bend the nose clip 10 until the back surface 12b of the clip body comes into contact with a pair of side surfaces S of the regular triangle prism P (FIG. 7(b)). Then, the pressing force F was removed and the nose clip 10 was allowed to restore, and after 15 minutes, the interior angle θ (in degrees) of the bent portion of the nose clip 10 was measured (FIG. 7(c)). Same experiment was also performed on the nose clip of inventive example 2, and comparative examples 1 and 2. The experiment was performed on plural samples of same structure. Measurement result of the interior angle is shown in Table 1 below.

TABLE 1

| | Inventive | Comparative | Inventive | Comparative |
|---|---|---|---|---|
| | example 1 | example 1 | example 2 | example 2 |
| θ (Sample 1) | 81 | 82 | 71 | 73 |
| θ (Sample 2) | 75 | 78 | 72 | 72 |
| θ (Sample 3) | | | 71 | 72 |
| θ (Mean) | 78 | 80 | 71.33 | 72.33 |

As is evident from Table 1, in the case of the nose clip having linear grooves 14 (inventive examples 1 and 2), the interior angle θ of the bent portion which was allowed to restore for 15 minutes after bending to the angle of 60 degrees, is smaller than in the case of the nose clip having no linear grooves (comparative examples 1 and 2), and therefore, the nose clip having linear grooves 14 is superior in shape-retaining capability. Also, the nose clip used in the experiment (especially, inventive example 1) is relatively thin with thickness as small as 0.5 mm, and as a result of synergistic effect of linear grooves 14, is very flexible. These characteristics of the nose clip greatly influence the fit feeling in a mask for general purpose (for example, mask 20). The more flexible a nose clip is, and the better shape-retaining capability a nose clip has, the better fit feeling is given to its wearer.

### Experiment 2

Next, in order to evaluate the capability of maintaining the state of close fit of a mask for industrial purpose (for example, mask 30), an experiment on the characteristics of a mask was performed as described below.

As an inventive example 1 of a mask, a strip-shaped resin material containing PET (polyethylene terephthalate), PC (polycarbonate), SEBS (styrene ethylene butylene styrene copolymer), PE (polyethylene) and EpxPE (epoxy polyethylene) in ratio by weight of PET/PC/SEBS/PE/EpxPE=55/15/15/12.5/2.5 of thickness T=2 mm and width W=5 mm was subjected to emboss processing to form a plurality of linear grooves 14 in a continuous repeating pattern, and then, the strip-shaped material having linear grooves formed thereon was cut to pieces of length L=90 mm to obtain a nose clip 10 (FIG. 1). This nose clip 10 was attached to an edge portion 34 of a mask body 32 of non-woven fabric to obtain a mask 30 (FIG. 6). In the nose clip 10 obtained, the interval D (FIG. 4(a)) of the first linear grooves 14a was 18 mm, the depth of each linear groove 14 was about 0.2 mm to 0.3 mm, and the cross-sectional shape of each linear groove 14 was generally U-shape (V-shape with rounded tip) of width about 0.5 mm to about 1 mm.

As an inventive example 2 of a mask, the product “Forte®” (polyethylene sheet of high draw ratio), manufactured by Sekisui Seikei Co. (Osaka, Japan) was used as in inventive example 1, to form a nose clip 10 of thickness T=1 mm, width W=4 mm, length L=90 mm, with the interval D (FIG. 4(a)) of the first linear grooves 14a=18 mm, the depth of each linear groove 14 of about 0.2 mm to 0.3 mm, the width of each linear groove 14 of about 0.5 mm to about 1 mm, and with the cross-sectional shape of each linear groove 14 of generally U-shape (V-shape with rounded tip). This nose clip 10 was attached to the edge portion 34 of the mask body 32 of non-woven fabric to obtain a mask 30 (FIG. 6).

As a comparative example 1 of a mask, a mask having a nose clip of same material and same size as the nose clip 10 of the mask 30 in inventive example 1 but without the 1st to 3rd linear grooves 14a to 14c, attached to an edge portion 34 of a mask body 32 of non-woven fabric was provided.

As a comparative example 2 of a mask, a mask having a nose clip of same material and same size as the nose clip 10 of the mask 30 in Inventive example 2 but without the 1st to 3rd linear grooves 14a to 14c, attached to an edge portion 34 of a mask body 32 of non-woven fabric was provided.

As a comparative example 3 of a mask, a mask 30 in Inventive example 1 but with the nose clip 10 removed was provided.

With a subject wearing the mask 30 of inventive example 1 properly on the face, leak rate Q of the mask 30 with respect to sodium chloride dust was measured using the leak rate tester “MT-9000” manufactured by Sibata Kagaku Co. (Taito-ku, Tokyo) in a closed room. The leak rate Q was calculated by following equation:

Leak rate Q (%)=dust density on the secondary side (inside the mask) (mg/m³)/dust density on the primary side (in closed room) (mg/m³)×100

Same experiment was performed on a mask of inventive example 2 and comparative examples 1 to 3. Measurement result of the leak rate Q of respective masks is shown in Table 2 below.

TABLE 2

| | | | | | Com- |
|---|---|---|---|---|---|
| | | Com- | | Com- | parative |
| | Inventive | parative | Inventive | parative | exam- |
| | example 1 | example 1 | example 2 | example 2 | ple 3 |
| Q (Sample 1) | 24.54 | 100.0 | 1.92 | 5.78 | 20.20 |
| Q (Sample 2) | 3.23 | 19.29 | 2.89 | 1.71 | |
| Q (Sample 3) | | | 0.69 | 0.69 | |
| Q (Sample 4) | | | 1.60 | 3.80 | |
| Q (Sample 5) | | | | 1.14 | |
| Q (Mean) | 13.89 | 59.65 | 1.775 | 2.624 | 20.20 |

As is evident from Table 2, a mask 30 including a nose clip having linear grooves 14 has smaller leak rate Q than a mask including a nose clip having no linear grooves. Such characteristics of a mask influence the capability of maintaining the state of close fit in an industrial mask (for example, mask 30), and the smaller the leak rate Q is, the higher is the capability of maintaining the state of close fit.

What is claimed is:

1. A nose clip that comprises:
a strip-shaped clip body that has a major surface and a back surface opposite to the major surface, the clip body also having an edge extending in a longitudinal direction; and
a plurality of linear grooves provided on at least one of the major surface and the back surface of the clip body, each linear groove extending in a direction intersecting the edge of the clip body.

2. The nose clip of claim 1, wherein the plurality of linear grooves include at least one linear groove extending in a direction intersecting the edge at an acute angle.

3. The nose clip of claim 1, wherein the plurality of linear grooves include at least one linear groove extending in a direction intersecting the edge at a right angle.

4. The nose clip of claim 1, wherein the plurality of linear grooves include at least two linear grooves extending in directions intersecting said edge at mutually different angles.

5. The nose clip of claim 1, wherein the plurality of linear grooves include at least two linear grooves extending parallel to each other.

6. The nose clip of claim 1, wherein the plurality of linear grooves include at least three linear grooves arranged at regular intervals.

7. The nose clip of claim 1, wherein the plurality of linear grooves are uniformly formed in a repeating pattern on the major surface or the back surface of the clip body.

8. A mask comprising a mask body and a nose clip attached to the mask body, characterized in that the nose clip comprises a resinous nose clip of claim 1.

9. The mask of claim 8, wherein the nose clip is attached to the mask body such that a surface of the clip body, on which the plurality of linear grooves are provided, is oriented toward a nose of a wearer.

10. The mask of claim 8, wherein the nose clip is attached to the mask body such that a surface of the clip body, on which the plurality of linear grooves are provided, is oriented away from a nose of a wearer.
